(19) United States
(12) Patent Application Publication
(10) Pub. No.: US 2024/0329657 A1
(43) Pub. Date: Oct. 3, 2024

(54) METHODS AND APPARATUS FOR ADDRESSING WORK ZONES DETECTED BY AUTONOMOUS VEHICLES

(71) Applicant: Nuro, Inc., Mountain View, CA (US)

(72) Inventors: Jia Pu, Menlo Park, CA (US); Chengyao Li, Toronto (CA); Eugene Wei-Hao Fang, Menlo Park, CA (US); Otitodilichukwu Olisaebuka Anammah, San Francisco, CA (US); Benjamin Tian-You Thomsen, San Francisco, CA (US); Justin Zhong, Oakland, CA (US)

(73) Assignee: Nuro, Inc., Mountain View, CA (US)

(21) Appl. No.: 18/618,779

(22) Filed: Mar. 27, 2024

Related U.S. Application Data
(60) Provisional application No. 63/493,280, filed on Mar. 30, 2023.

(51) Int. Cl. G05D 1/617; G05D 1/227; G05D 107/13; G05D 109/10

(52) U.S. Cl. CPC G05D 1/617; G05D 1/227; G05D 2107/13; G05D 2109/10

(57) ABSTRACT

According to one aspect, a method includes autonomously operating a vehicle along a first path, identifying a work zone, and determining whether the vehicle is able to continue operating along the first path after identifying the work zone. When it is determined that the vehicle is not able to continue operating along the first path, it is determined whether an autonomy system is able to identify a second path that routes around the work zone. When the autonomy system is able to identify the second path, the vehicle is autonomously operated along the second path. When the autonomy system is unable to identify the second path, the method includes requesting assistance from a teleoperations monitor arrangement. The vehicle is configured to obtain, from the teleoperations monitor arrangement, a waypoint or a first indication of a teleoperations operation arrangement assigned to remotely operate the vehicle around the work zone.

### PRIORITY CLAIM

This patent application claims the benefit of priority under 35 U.S.C. § 119 to U.S. Provisional Patent Application No. 63/493,280, filed Mar. 30, 2023, and entitled “METHODS AND APPARATUS FOR ADDRESSING WORK ZONES DETECTED BY AUTONOMOUS VEHICLES,” which is incorporated herein by reference in its entirety.

### TECHNICAL FIELD

The disclosure relates to providing systems for autonomous vehicles. More particularly, the disclosure identifying zones which may pose a challenge to autonomous vehicles.

### BACKGROUND

Fleets of autonomous or semi-autonomous vehicles often utilize remote operators, e.g., operators of teleoperations systems or operators of remote controls. When a vehicle that is operating autonomously encounters an issue, a teleoperations system may effectively take control of the vehicle, as needed, to address the issue. An operator of a teleoperations system generally keeps an eye on a display screen which depicts the environment around the vehicle that the operator is monitoring, and is ready to take control of the vehicle, as for example when the vehicle may not operate safely in autonomous mode. When the operator takes control of the vehicle, the operator uses the teleoperations system to remotely operate the vehicle. In some situations, a vehicle that is operating autonomously may effectively request that an operator of a teleoperations system take control of the vehicle.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic side view representation of a vehicle approaching a work or construction zone in accordance with an embodiment.

FIG. 4B is a diagrammatic top view representation of a vehicle approaching a work or construction zone, e.g., vehicle 401 and work zone 450 of FIG. 4A, in accordance with an embodiment.

FIG. 5 is a diagrammatic representation of an overall system which enables a vehicle to request assistance from a teleoperations monitor arrangement in accordance with an embodiment.

FIG. 6 is a process flow diagram which illustrates a method of an autonomous vehicle reacting to a detection of a potential work or construction zone in accordance with an embodiment.

FIG. 7 is a process flow diagram which illustrates a method of a teleoperations monitor arrangement processing a supervisory request which indicates a work zone in accordance with an embodiment.

FIG. 8 is a block diagram representation of interactions between a sensor system and an autonomy system of an autonomous vehicle with respect to the identification of a work zone in accordance with an embodiment.

FIG. 9 is a process flow diagram which illustrates a method of identifying a work zone and characteristics of the work zone in accordance with an embodiment.

FIG. 10 is a process flow diagram which illustrates a method of responding to the detection of a work zone based on the relevancy of the work zone in accordance with an embodiment.

FIGS. 11A-C are a process flow diagram which illustrates a method of responding to a detected work zone within a framework that includes a teleoperations monitor arrangement in accordance with an embodiment.

FIG. 12 is a process flow diagram which illustrates a method of effectively confirming a presence of a work zone in accordance with an embodiment.

### DESCRIPTION OF EXAMPLE EMBODIMENTS

### General Overview

According to one embodiment, a method includes autonomously operating a vehicle along a first path from a first point to a second point, the vehicle including an autonomy system that enables the vehicle to operate autonomously, wherein the autonomy system includes a perception system. The method also includes identifying, using the perception system, a work zone, and determining, using a planning system, whether the vehicle is able to continue operating along the first path after identifying the work zone. When it is determined that the vehicle is not able to continue operating along the first path, it is determined, using the autonomy system, whether the autonomy system is able to identify a second path to the second point that routes around the work zone. When it is determined that the autonomy system is able to identify the second path, the vehicle is autonomously operated along the second path, and when it is determined that the autonomy system is unable to identify the second path, the method includes requesting assistance from a teleoperations monitor arrangement. The vehicle is configured to obtain, from the teleoperations monitor arrangement, one selected from a group including a waypoint and a first indication of a teleoperations operation arrangement assigned to remotely operate the vehicle around the work zone.

In another embodiment, logic is encoded in one or more tangible non-transitory, computer-readable media for execution and when executed, the logic is operable to operate a vehicle autonomously along a first path from a first point to a second point, the logic operable to operate the vehicle autonomously being further operable to implement a perception system. The logic is also operable to identify, using the perception system, a work zone, and to determine whether the vehicle is able to continue operating along the first path after identifying the work zone. The logic is further operable to determine whether a second path to the second point that routes around the work zone is feasible when it is determined that the vehicle is not able to continue operating along the first path, and to operate the vehicle autonomously along the second path when it is determined that the autonomy system is able to identify the second path. When it is determined that the autonomy system is unable to identify the second path, the logic is operable to request assistance from a teleoperations monitor arrangement, wherein vehicle is configured to obtain, from the teleoperations monitor arrangement, one selected from a group including a waypoint and a first indication of a teleoperations operation arrangement assigned to remotely operate the vehicle around the work zone.

In still another embodiment, a system includes a teleoperations monitor arrangement and a vehicle that has an autonomy system. The autonomy system has logic operable to operate the vehicle autonomously along a first path from a first point to a second point. The logic is further operable to implement a perception system, the perception system including logic operable to identify a work zone along the first path, wherein the autonomy system further includes logic operable to determine whether the vehicle is able to continue operating along the first path after identifying the work zone and to determine whether a second path to the second point that routes around the work zone is feasible when it is determined that the vehicle is not able to continue operating along the first path. When the logic operable to determine whether the second path is feasible determines that the second path is not feasible, the logic is further operable to provide a supervisory request to the teleoperations monitor arrangement. The teleoperations monitor arrangement is arranged to determine whether the vehicle is capable of operating autonomously around the work zone.

An autonomous vehicle operates within a framework which includes a teleoperations monitor arrangement which may be contacted by the autonomous vehicle to monitor the autonomous vehicle to determine whether control of the autonomous vehicle is to be given to a teleoperations operator arrangement. The autonomous vehicle is arranged to determine when a work or construction zone is present in, or along, a path travelled by the autonomous vehicle. When the autonomous vehicle detects or identifies the work zone, and determines that there is no feasible, appropriate alternative path that efficiently routes around the work zone, the autonomous vehicle may provide a supervisory request to a teleoperations monitor arrangement which may then assess the work zone and potentially assign a teleoperations operator arrangement to remotely drive the vehicle past or around the work zone.

### DESCRIPTION

When autonomous vehicles operate, autonomous vehicles use sensors to continuously obtain information relating to a surrounding environment. The information is typically processed to identify obstacles that the vehicle generally needs to address in order to continue operating in a safe manner. The vehicle may continue to operate autonomously while effectively addressing some obstacles. For other obstacles, the vehicle may determine that continuing to operate autonomously may not be possible. By way of example, when a vehicle that is operating autonomously detects a work zone or a construction zone, the vehicle may determine that it may be prudent to cease autonomous operation and, hence, to request assistance or intervention.

A work zone may generally be an area on or near a roadway within which work is currently occurring, is planned to occur, and/or has occurred. The work may include, but is not limited to including, construction work, utility work, the painting of lane markings, tree trimming, and/or road work. Road work may include pouring concrete, removing a road surface, paving a road surface, digging into a road surface, and/or otherwise performing repairs on a road. The work zone may generally occupy or otherwise encompass an otherwise substantially drivable area of a road. That is, a work one may prevent an area of a road from being drivable by a vehicle such as an autonomous vehicle.

A platform which supports autonomous vehicles may include one or more teleoperations monitor arrangements which may each be used to monitor multiple autonomous vehicles. The platform also includes one or more teleoperations operation arrangements which each enable a vehicle to be remotely controlled, e.g., when the vehicle determines that there may be an issue which may need to be addressed. Autonomous vehicles which may be monitored by a teleoperations monitor arrangement and remotely controlled by a teleoperations operating arrangement may be self-monitoring such that when an autonomous vehicle determines that monitoring using a teleoperations monitor arrangement may be beneficial, the autonomous vehicle may request monitoring. Upon obtaining or otherwise receiving a request for monitoring from the autonomous vehicle, the teleoperations monitor arrangement may monitor the autonomous vehicle and assign a teleoperations operating arrangement to remotely control the autonomous vehicle as appropriate. In one embodiment, the request for monitoring may be issued by the autonomous vehicle to the teleoperations monitor arrangement when the autonomous vehicle identifies a work zone or a potential work zone. The teleoperations monitor arrangement may assess the situation associated with the work zone or potential work zone, and assign a teleoperations operating arrangement to remotely control the vehicle to substantially guide the vehicle past or around the work zone.

By enabling an autonomous vehicle to send a supervisory request to a teleoperations monitor arrangement when a work zone or potential work zone is identified, work zones may be addressed in a safe and efficient manner. The vehicle may process data obtained from sensors mounted on the vehicle to identify a work zone, determine whether the vehicle may navigate autonomously past or around the work zone, and request monitoring from a teleoperations monitor arrangement as needed. In one embodiment, the vehicle may, upon identifying a work zone, determine whether a different path around or past the work zone may be identified, and use the different path to continue navigating or operating autonomously. In such an embodiment, the vehicle may request monitoring when the vehicle is unable to identify a suitable different path. A work zone may be identified based upon objects, e.g., traffic cones and/or temporary traffic control signage, which are present in or near a lane of a road. In addition, a work zone may also be identified based on activity detected, e.g., a worker directing traffic and/or an excavator digging. Further, a work zone may be identified based on the condition of a road, e.g., a road surface may appear to have wet concrete or a road surface may be broken into chunks.

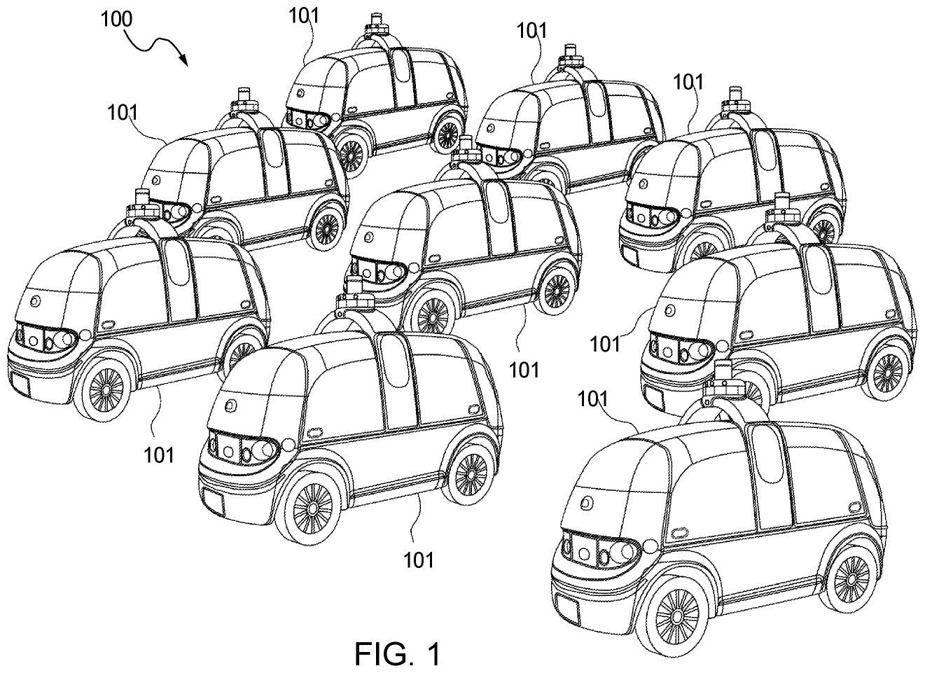

Autonomous vehicles which are capable of detecting work or construction zones, and taking or otherwise initiating action to address the work or construction zones, may be part of a fleet of vehicles that may be monitored by a teleoperations monitoring arrangement. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

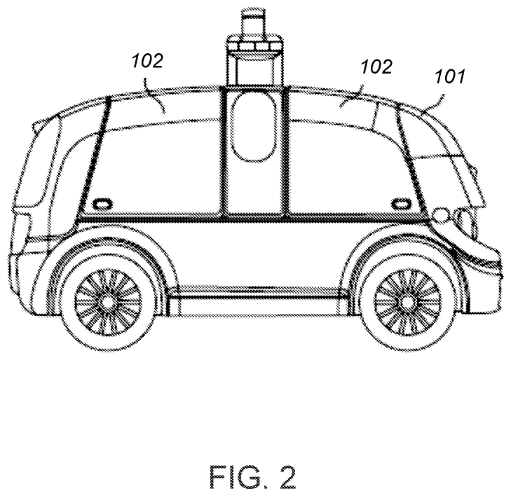

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

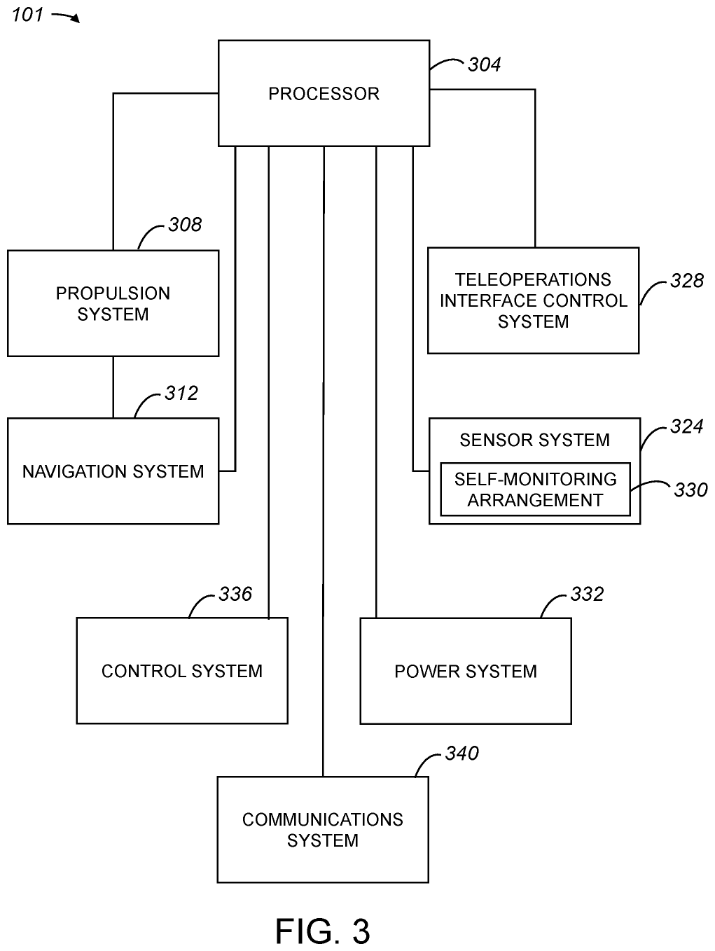

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a teleoperations interface control system 328a power system 332, a control system 336, and a communications system 340. It should be appreciated that processor 304, propulsion, n system 308, navigation system 312, sensor system 324, teleoperations interface control system 328, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Teleoperations interface control system 328 generally enables vehicle 101 to be controlled remotely, as for example by a teleoperations operator arrangement. That is, teleoperations interface control system 328 enables vehicle 101 to operate by obtaining and processing instructions provided by a teleoperations operator arrangement. Additionally, teleoperations interface control system 328 may enable vehicle 101 to determine when vehicle 101, while operating autonomously, may benefit from being controlled via teleoperations and to request remote monitoring and/or control by a teleoperator. In one embodiment, teleoperations interface control system 328 enables vehicle 101 to communicate with a teleoperations monitor arrangement, a teleoperations operator arrangement, and/or a teleoperations queue. A teleoperations monitor arrangement, a teleoperations operator arrangement, and a teleoperations queue will be discussed below.

In one embodiment, sensor system 324 is configured to enable autonomous vehicle 101 to identify an issue or a potential issue which may effectively necessitate control of autonomous vehicle 101 remotely, as for example using teleoperations interface control system 328. A self-monitoring arrangement 330 of sensor system 324 may generally enable autonomous vehicle 101 to monitor itself and/or its surroundings to determine if there are any issues or potential issues which may have an effect on the autonomous operation of autonomous vehicle 101. For example, self-monitoring arrangement 330 may identify an issue relating to a work or construction zone detected using information collected by sensors included in sensor system 324.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving. The model may be used to facilitate motion planning that generates paths that may be navigated or traversed by vehicle 101.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

Along routes traversed by vehicles operating autonomously, there may be work or construction zones which may impact the ability of the vehicles to operate autonomously. Work zones are generally areas on or near a road within which there is work that is being done, work that has just been completed, and/or work that is to be done. Such work may include, but is not limited to including, maintenance work such as painting lane lines, clearing work such as removing a fallen tree from a road, and/or construction work. A work zone may also involve a temporary or newly defined lane. In some situations, a temporary lane may be a two-way lane within which traffic flow is controlled by one or more workers.

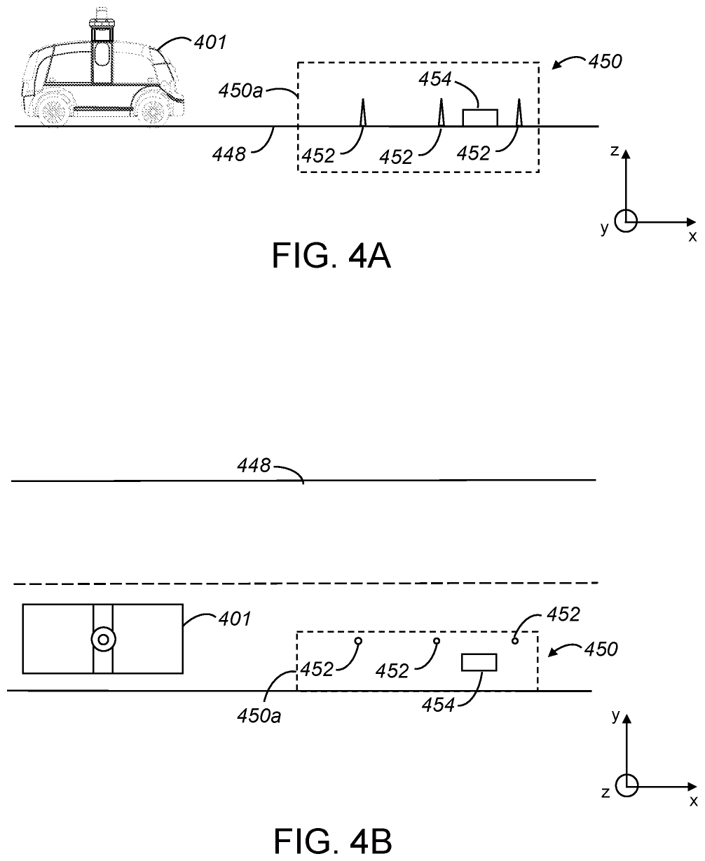

Referring next to FIGS. 4A and 4B, the identification of a work or construction zone by a vehicle will be described in accordance with an embodiment. A vehicle 401, e.g., an autonomous vehicle, operates on a roadway 448. As vehicle 401 operates or travels, vehicle approaches a zone or area 450. In the described embodiment, zone 450 may be at least partially defined by one or more traffic cones 452 positioned on roadway 448. Zone 450 has a front side or edge 450a which may be an edge that vehicle 401 may first encounter as vehicle 401 approaches zone 450. It should be appreciated that while traffic cones 452 may effectively delineate zone 450, zone 450 may be substantially delineated without traffic cones 452 in some situations.

Within zone 450, an object 454 may be present. Object 454 may be, but is not limited to being, a construction or road work vehicle such as an excavator, a temporary road sign, an obstacle such as a pile of dirt or a fallen tree, a trench, a disabled vehicle, and/or a worker. It should be appreciated that multiple objects 454 may generally be within zone 450. As vehicle 401 approaches zone 450, sensors (not shown) on vehicle 401 may collect data that is processed to identify traffic cones 452 and object 454 and, further, to substantially determine the existence of zone 450.

While traffic cones 452 may often be placed on or near roadway 448 to essentially delineate zone 450, other apparatuses may instead be used to delineate zone 450. For example, pylons and/or temporary road barriers may delineate zone 450. In general, substantially any apparatus which may effectively define edges of zone 450 may be placed on or near roadway 448, and may be detected or otherwise identified by vehicle 401.

As vehicle 401 approaches zone 450, vehicle 401 may be operating autonomously. Vehicle 401 may request intervention by issuing a supervisory request to a teleoperations monitor arrangement. That is, vehicle 401 may determine that operating autonomously may not be possible and, therefore, may request that a teleoperations monitor assess zone 450 and either cause a teleoperator to remotely operate vehicle 401 around zone 450 or effectively confirm that vehicle 401 may safely operate autonomously around zone 450.

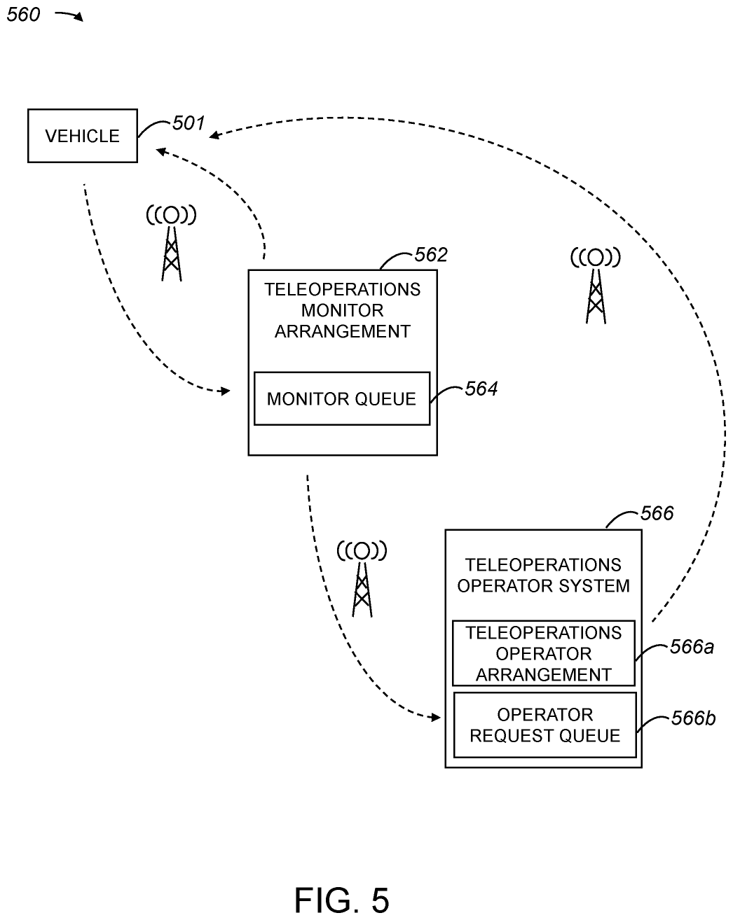

A platform which enables a vehicle such as vehicle 401 to request assistance from a teleoperations monitor arrangement typically includes the teleoperations monitor arrangement and one or more teleoperations operator arrangement. FIG. 5 is a diagrammatic representation of an overall platform which enables a vehicle to request assistance from a teleoperations monitor arrangement in accordance with an embodiment. A platform 560 includes an autonomous vehicle 501, a teleoperations monitor arrangement 562, and a teleoperations operator system 566.

Vehicle 501 is configured to operate autonomously and, when vehicle detects a work zone, to request monitoring by teleoperations monitor arrangement 562. Monitoring may be requested by sending or providing a supervisory request from vehicle 501 to teleoperations monitor arrangement 562 through a network. Teleoperations monitor arrangement 562 may monitor vehicle 501, and determine whether the work zone that vehicle 501 detected is to be addressed by a teleoperations operator arrangement 566a. When teleoperations monitor arrangement 562 determines that control of vehicle 501 is to be relinquished, at least temporarily, to teleoperations operator arrangement 566a, teleoperations monitor arrangement 562 may communicate with teleoperations operator system 566 over a network.

Teleoperations monitor arrangement 562 includes, in one embodiment, a monitor queue 564 configured to queue supervisory requests obtained by teleoperations monitor arrangement 562 from vehicles such as vehicle 501. Teleoperations monitor arrangement 562 may process supervisory requests, including a request initiated by vehicle 501, by monitoring vehicles in any suitable order. A suitable order for processing supervisory requests may include, but are not limited to including, a first-in-first-out order and/or an order based on priority or severity levels of queued supervisory requests. It should be appreciated that if monitor queue 564 is substantially empty when a supervisory request is obtained from vehicle 501, that supervisory request may be processed substantially immediately, or effectively without being queued.

Teleoperations operator system 566 includes at least one teleoperations operator arrangement 566a that is arranged to be used by an operator or a controller to remotely control vehicle 501 e.g., in response to a supervisory request based on vehicle 501 identifying an upcoming work zone. In one embodiment, teleoperations operator system 566 includes an operator request queue 566b which is configured to queue requests for control of a vehicle such as vehicle 501 by teleoperations operator arrangement 566a. Requests for control may generally be processed or otherwise assigned to teleoperations operator arrangement 562 from operator request queue 566b in any suitable order including, but not limited to including, a first-in-first-out order and/or an order based on the priority or severity levels associated with the situation vehicles such as vehicle 501 are in or otherwise facing.

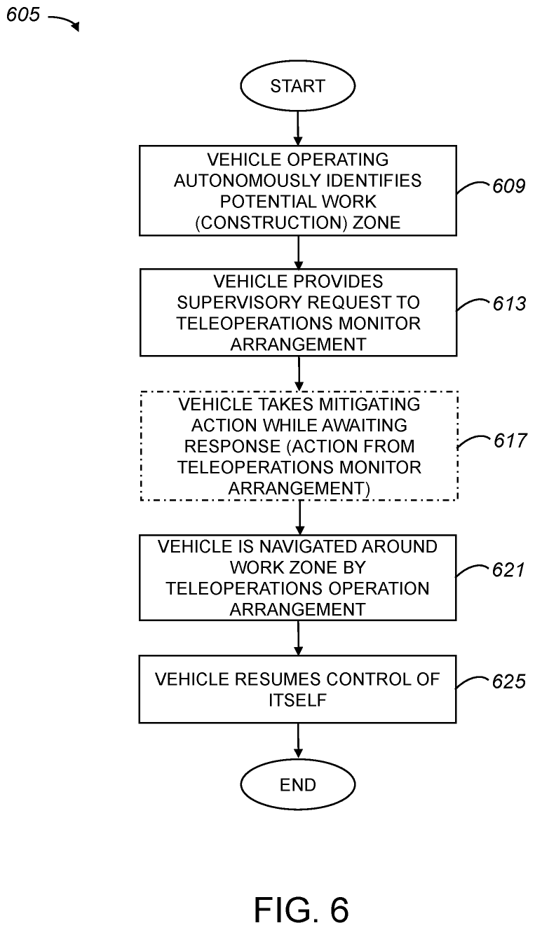

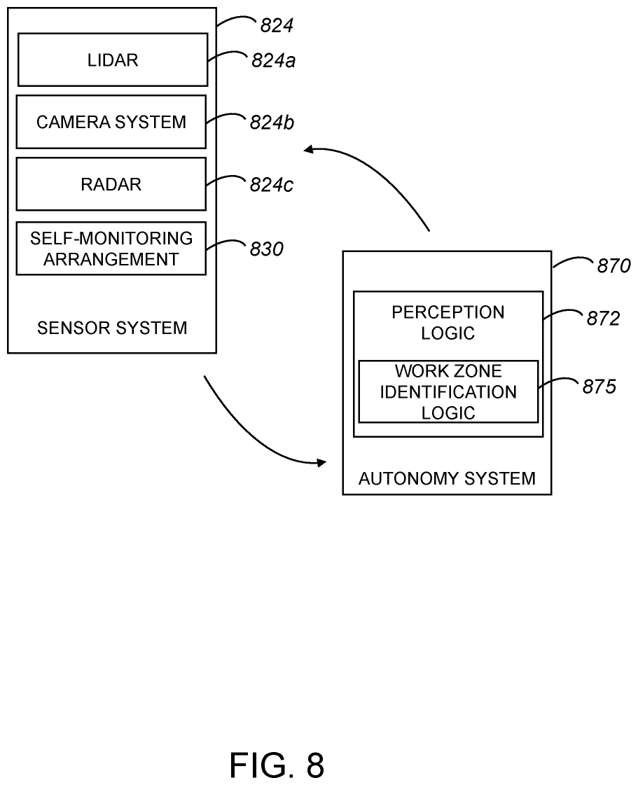

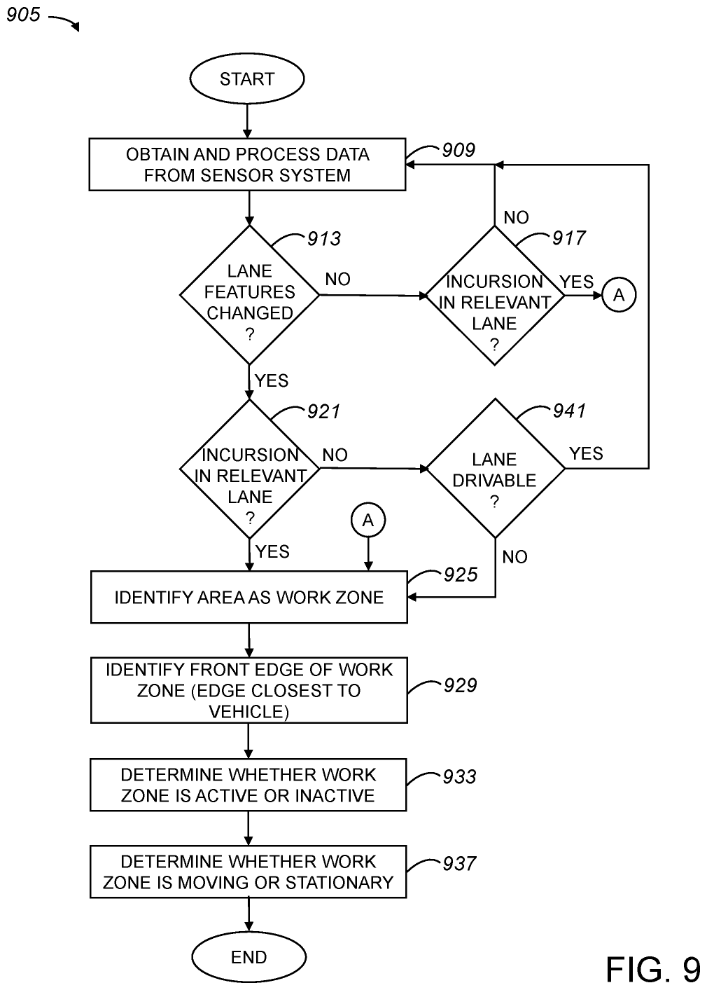

With reference to FIG. 6, a method of an autonomous vehicle reacting to a detection of a potential work or construction zone will be described in accordance with an embodiment. A method 605 of reacting to the identification of a potential work or construction zone begins at a step 609 in which a vehicle which is operating autonomously or in an autonomous mode identifies a potential work or construction zone. The vehicle may identify a work zone based on objects detected by sensors on the vehicle and essentially identified by a perception system of the vehicle. The identification of a work zone will be discussed in more detail below with reference to FIGS. 8 and 9.

Once the vehicle identifies a potential work zone, the vehicle provides a supervisory request to a teleoperations monitor arrangement in a step 613. The vehicle may send the request to the teleoperations monitor arrangement over a network, e.g., a wireless network or a cellular network, and the request may provide information relating to the potential work zone that the vehicle is requesting that the teleoperations monitor arrangement process.

In an optional step 617, the vehicle effectively takes a mitigating action while awaiting a response from the teleoperations monitor arrangement. The response from the teleoperations monitor arrangement may involve the teleoperations monitor arrangement assigning a teleoperations operation arrangement to remotely operate the vehicle. The mitigating action that may optionally be taken by the vehicle includes, but is not limited to including, coming to a stop and/or pulling over to the side of a road.

From step 613, or from optional step 617, process flow proceeds to a step 621 in which the vehicle is navigated around the work zone by a teleoperations operation arrangement, i.e., a teleoperations operation arrangement that is substantially assigned by the teleoperations monitor arrangement. In other words, the teleoperations operation arrangement is used to operate the vehicle to drive around, deter around, and/or avoid the work zone.

After the vehicle is navigated around the work zone, the vehicle resumes control of itself in a step 625. The vehicle may resume control of itself after a teleoperations operation arrangement provides an instruction to the vehicle to resume control, as for example after the teleoperations operation arrangement essentially verifies that the vehicle is past the work zone. However, it should be appreciated that the vehicle may instead take back control from the teleoperations operation arrangement and resume operating autonomously once the vehicle is effectively clear of the work zone. Upon the vehicle resuming control of itself, the method of reacting to the identification of a potential work or construction zone is completed.

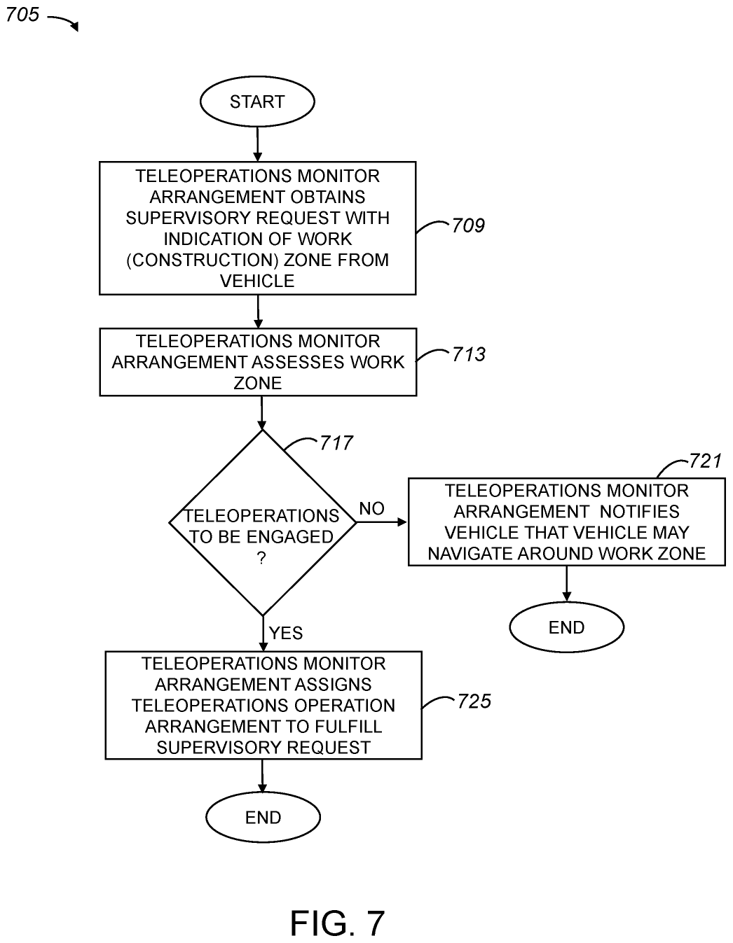

FIG. 7 is a process flow diagram which illustrates a method of a teleoperations monitor arrangement processing a supervisory request which indicates a work zone in accordance with an embodiment. A method 705 of processing a supervisory request which indicates a work zone begins at a step 709 in which a teleoperations monitor arrangement obtains a supervisory request which indicates a work zone from a vehicle.

In a step 713, the teleoperations monitor arrangement assesses the work zone. That is, the teleoperations monitor arrangement uses information provided in the supervisory request and information provided to teleoperations monitor arrangement from sensors on the vehicle to assess the work zone identified by the vehicle. Assessing the work zone may include, but is not limited to including, ascertaining whether the vehicle may safely navigate the work zone autonomously.

A determination is made in a step 717 as to whether a work zone is to be navigated by a teleoperations operation arrangement. In other words, it is determined whether teleoperations is to be engaged. If it is determined that teleoperations is not to be engaged, the implication is that the work zone is either not a work zone or is a work zone around which the vehicle may safely navigate around while in autonomous mode. As such, process flow proceeds to a step 721 in which the teleoperations monitor arrangement notifies the vehicle that the vehicle may navigate around the work zone in autonomous mode. Once the vehicle is notified, the method of processing a supervisory request that indicates a work zone is completed.

Alternatively, if it is determined in step 717 to teleoperations is to be engaged, then in a step 725, the teleoperations monitor arrangement assigns a teleoperations operation arrangement to fulfill the supervisory request. In one embodiment, the teleoperations monitor arrangement may also notify the vehicle that a teleoperations operation arrangement will take control of the vehicle to navigate past or around the work zone. The method of processing a supervisory request which indicates a work zone is completed upon the teleoperations operation arrangement being assigned.

In order to identify a work zone, a perception system or, more generally, an autonomy system of an autonomous vehicle may obtain data collected by sensors on the vehicle and process the data. When objects and positioning of the objects indicate a work zone, the vehicle may then request that a teleoperations monitor arrangement determine whether the vehicle is to be controlled remotely to avoid the work zone.

FIG. 8 is a block diagram representation of interactions between a sensor system and an autonomy system of an autonomous vehicle with respect to the identification of a work zone in accordance with an embodiment. A sensor system 824 of an autonomous vehicle may cooperate with an autonomy system 870 of the autonomous vehicle to identify the presence of a work zone in the vicinity of the vehicle, e.g., along a path that the vehicle is planning to traverse.

Sensor system 824 may include one or more lidars 824a, one or more camera system 824b, one or more radars 824c, and a self-monitoring arrangement 830. It should be appreciated that sensor system 824 may include other sensors including, but not limited to including, those mentioned above with respect to sensor system 324 of FIG. 3.

Autonomy system 870 includes hardware and/or software logic which enables data from sensor system 824 to be processed to facilitate the autonomous operation of a vehicle. Autonomy system 870 includes perception logic 872 that performs functions including, but not limited to including, object detection, object identification, and lane detection with respect to roadways. Autonomy system 870 also includes planning logic 876 that performs functions such as planning, or otherwise identifying, paths which a vehicle may traverse between a source and a destination, and may determine whether a vehicle is able to continue operating along a particular path. Perception logic 872 also generally enables the vehicle to localize itself within its surrounding environment. Data collected by lidar 824a, camera system 824b, and radar 842c may be processed by perception logic 872 to detect and to identify objects and lanes. In one embodiment, perception logic 872 may identify traffic cones or other indicators of a potential work zone, and utilize work zone identification logic 874 to essentially determine whether a work zone is in existence.

Work zone identification logic 874 is configured to substantially identify the existence, or a likely existence, of a work zone or a construction zone. For example, work zone identification logic 874 may identify a boundary of a work zone, including a boundary or an edge that is closest to a vehicle as the vehicle approaches the work zone. In general, work zone identification logic 874 identifies scenarios relating to road work that may cause a vehicle to deviate from a planned driving route and/or otherwise have an impact on the ability of the vehicle to drive a planned route. Work zone identification logic 875 may also determine whether a work zone is relevant, or otherwise has an effect on the ability for a vehicle to drive a planned driving route.

In one embodiment, work zone identification logic 874 may identify whether an identified work zone is active, or inactive. An active work zone may include individuals, machines, and/or vehicles that are moving, while an inactive work zone may include machines and/or vehicles that are substantially stationary or parked. Work zone logic 874 may further identify whether an identified work zone is moving or stationary. A moving work zone may be, for example, a work zone that involves active painting of lane markings and/or street cleaning. That is, a moving work zone may be a work zone with at least one boundary that moves as work is substantially performed. A stationary work zone may be a work zone for which boundaries are substantially fixed.

FIG. 9 is a process flow diagram which illustrates a method of identifying a work zone and characteristics of the work zone in accordance with an embodiment. A method 905 of identifying a work zone and characteristics of a work zone begins at a step 909 in which perception logic on a vehicle obtains and processes data collected by a sensor system on the vehicle. Processing the data may include, but is not limited to including, identifying objects and/or areas substantially in or near a path that is travelled by a vehicle.

Once the data obtained from the sensor system is processed, it is determined in a step 913 whether the data indicates that lane features, e.g., lane features of a lane in which a vehicle is travelling, have changed. That is, a determination is made as to whether expected or otherwise anticipated lane features in a particular area differ from what the data indicates. It should be appreciated that, in lieu of data obtained from the sensor system being used to determine whether lane features have changed, map data may instead be used.

If the determination in step 913 is that lane features have changed, then it is determined in a step 921 whether there is an incursion in a lane that is relevant to the vehicle. In other words, it is determined whether there is an obstruction in either a lane in which the vehicle is travelling or in an adjacent lane to the vehicle. The obstruction may be, in one embodiment, a change to a road surface such as a road surface that is broken up or newly formed, e.g., a road surface with wet cement or hot asphalt. If it is determined that there is an incursion in a relevant lane with respect to the vehicle, the process flow moves to a step 925 in which a work zone is identified, e.g., an area associated with changed lane features and and/or an incursion is identified as a work zone. It should be appreciated that while a work zone may be at least partially delineated by one or more traffic cones, a work zone is not necessarily delineated by one or more traffic cones.

After a work zone is identified, a front edge or border of the work zone is identified in a step 929. The front edge of a work zone may be, in one embodiment, an edge of the work zone that is closes to the vehicle as the vehicle approaches the work zone. By identifying the front edge, the vehicle may be able to determine how to stop to avoid crossing into the work zone.

Once the front edge or border of the work zone is identified, it is determined whether the work zone is active or inactive in a step 933. Then, in a step 938, it is determined whether the work zone is moving or stationary. Upon determining whether the work zone is moving or stationary, the method of identifying a work zone and characteristics of a work zone is completed.

Referring back to step 921 and a determination of whether there is an incursion in a relevant lane, if it is determined that there is no incursion in a relevant lane, the implication is that while lane features have changed, the vehicle may be able to operate autonomously through or around the changed lane features. Accordingly, a determination is made in a step 941 as to whether a relevant lane is drivable, or may be traversed by the vehicle in an autonomous mode.

If the determination in step 941 is that the lane is drivable, the indication is that there is no work zone which affects the vehicle. As such, process flow returns to step 909 in which data continues to be obtained and processed. Alternatively, if it is determined that the lane is not drivable, then a work zone is identified in step 925.

Returning to step 913, if the determination in step 913 is that lane features have not changed, then process flow proceeds to a step 917 in which it is determined whether there is an incursion in a relevant lane, or a lane that is relevant to the vehicle. If the determination is that there is an incursion in the relevant lane, the indication is that there is a work zone. Accordingly, process flow moves from step 917 to step 925 in which a work zone is effectively identified.

Alternatively, if the determination in step 917 is that there is no incursion in a lane relevant to the vehicle, the implication is that there is no work zone. As such, process flow returns to step 909 in which data continues to be obtained and processed.

As mentioned above, after identifying a work zone, the vehicle processes the work zone by substantially ensuring that an autonomy system responds appropriately, or takes appropriate measures, to address the work zone. By way of example, the vehicle may cease operating in an autonomous mode. In one embodiment, the vehicle may stop driving autonomously and notify a teleoperations monitor arrangement of a presence of a work zone and effectively request monitoring.

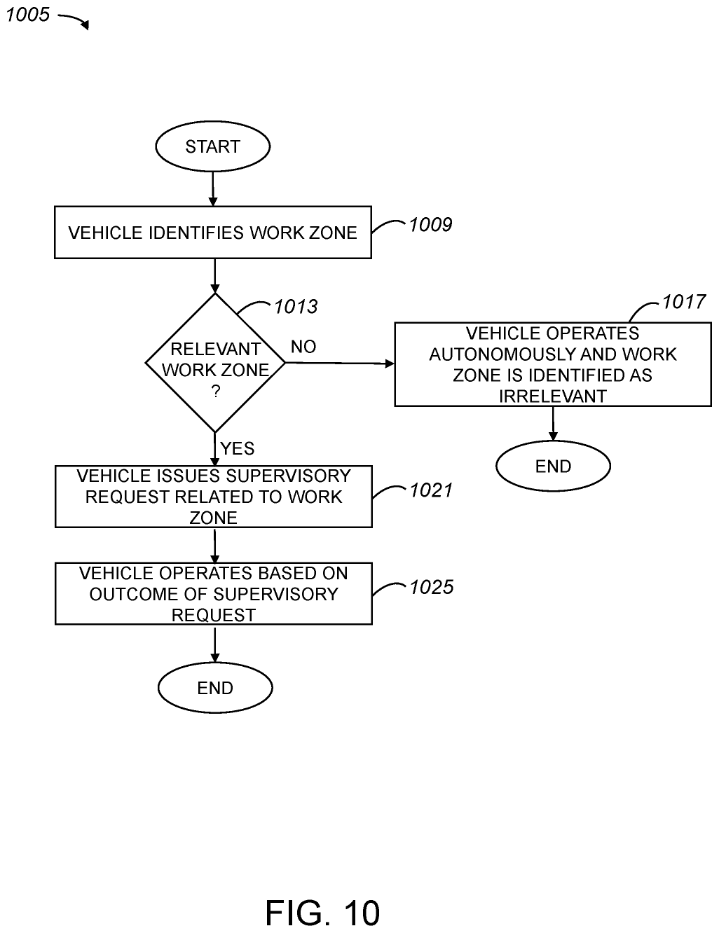

FIG. 10 is a process flow diagram which illustrates a method of responding to the detection of a work zone based on the relevancy of the work zone in accordance with an embodiment. A method 1005 of responding to the detection of a work zone by a vehicle begins at a step 1009 in which the vehicle identifies a work zone. Once the vehicle identifies a work zone, the vehicle determines in a step 1013 whether the work zone is relevant. In one embodiment, a determination of whether a work zone is relevant includes determining whether the work zone is likely to affect an ability of the vehicle to continue on a planned path. That is, a determination of whether a work zone is relevant may involve a determination of whether the vehicle may operate autonomously to effectively clear, or drive past or around, the work zone.

If it is determined in step 1013 that the work zone is relevant, then the vehicle issues, sends, or otherwise provides a supervisory request related to the work zone. The supervisory request is issued to a teleoperations monitor arrangement, and may include information which enables the work zone to be identified. It should be appreciated that the vehicle may issue the supervisory request at approximately the same time that the vehicle stops operating autonomously. After the supervisory request is issued, the vehicle operates based on the outcome of the supervisory request in a step 1025. The vehicle may operate autonomously or under the control of a teleoperations system, as determined by a response to the supervisory request. Upon the vehicle operating based on the outcome of the supervisory request, the method of responding to the detection of a work zone by a vehicle is completed.

Alternatively, if it is determined in step 1013 that the work zone is not relevant, process flow proceeds to a step 1017 in which the vehicle continues to operate autonomously, and the work zone is identified as substantially irrelevant with respect to the vehicle. Once the work zone is identified as substantially irrelevant, the method of responding to the detection of a work zone by a vehicle is completed.

As discussed above, when a vehicle identifies a work zone, the vehicle may issue a supervisory request to a teleoperations monitor arrangement. In lieu of issuing a supervisory request substantially automatically once a work zone is detected, a vehicle may instead first determine whether an autonomy system of the vehicle may identify an alternate path that the vehicle may drive autonomously to effectively navigate around or past the work zone.

Within a framework that includes a teleoperations monitor arrangement, a vehicle may first try to determine whether the vehicle may generate an alternative path to navigate around or past a work zone, and engage with a teleoperations monitor arrangement when such an alternative path does not appear to be feasible. The teleoperations monitor arrangement may be used to determine whether it may be possible for the vehicle to navigate autonomously past or around the work zone. For example, when a vehicle is either unable to determine a “route around” for a work zone, or unable to assess whether an identified route around is acceptable, the vehicle may request assistance from a teleoperations monitor arrangement. The teleoperations monitor arrangement may facilitate the determination of a route around of the work zone by the vehicle, may assess whether a route around of the work zone identified by the vehicle is acceptable, and/or may effectively assign a teleoperations operation arrangement to take control of the vehicle to drive the vehicle past or around the work zone.

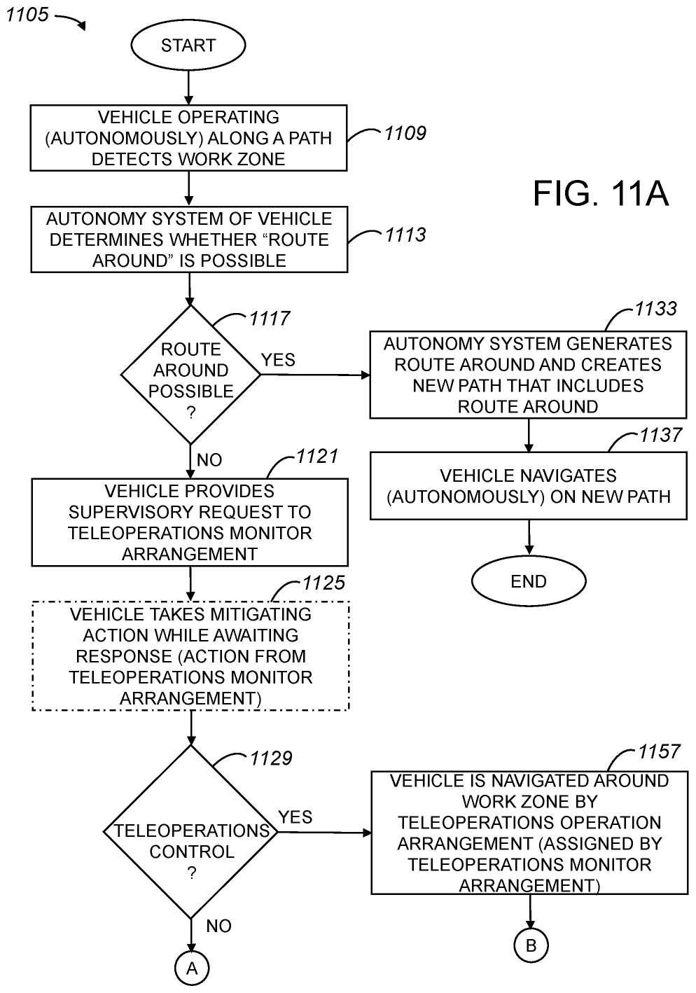

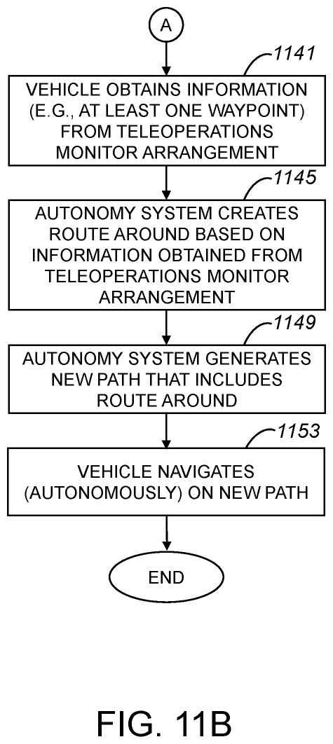

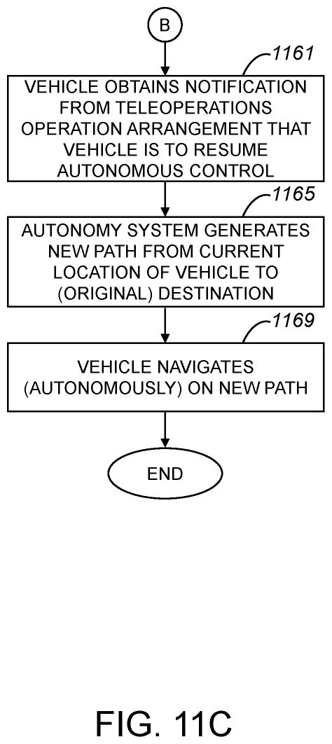

With reference to FIGS. 11A-C, a method of responding to a detected work zone within a framework that includes a teleoperations monitor arrangement will be described in accordance with an embodiment. A method 1105 of responding to a detected work zone in a path of a vehicle begins at a step 1109 in which the vehicle, which is operating autonomously to traverse a path, encounters a work zone in the path. The work zone may be in the path of the vehicle between a source point and a destination point, e.g., between a first endpoint and a second endpoint between which the path is defined. The work zone may be identified by any suitable characteristics including, but not limited to including, one or more traffic cones positioned or placed along a lane line, and/or one or more traffic cones positioned to at least partially define a geometric shape.

Once a work zone is effectively detected, an autonomy system of the vehicle determines whether a route around, or an alternative path segment that avoids the boundaries of a work zone, is possible in a step 1113. In other words, it is determined whether there is a route around that effectively meets predetermined conditions. The predetermined conditions may include, but are not limited to including, an amount or percentage of allowable deviation from an original path that may be associated with a route around, an amount of lane shifting allowed, and/or an allowable number of lanes away from the original path that a route around may use. In general, a potential route around that may be “map altering,” e.g., may involve driving in a manner that is inconsistent with what is depicted on a map of an environment, does not meet predetermined conditions. That is, a map altering route may be a route which, if driven by the vehicle, would violate at least one parameter, rule, and/or convention associated with a map. By way of example, if a potential route around may involve the vehicle driving on a side of a median in a road that generally carries opposing traffic, or otherwise driving against traffic in a lane, that potential route around may be identified as map altering and, therefore, may not be processed or considered by an autonomy system as a feasible route around. In general, a potential path which may include a segment in which a vehicle may drive in a direction that opposes traffic or in a direction that is inconsistent with traffic flow may be considered to be map altering.

A determination is made in a step 1117 as to whether a route around is possible, e.g., whether the autonomy system was able to define or identify a permissible or feasible route around. If it is determined that a route around is possible, the indication is that the vehicle may continue to operate autonomously without engaging a teleoperations monitor arrangement. As such, process flow moves from step 1117 to a step 1133 in which the autonomy system generates a route around and creates a new path that includes the route around. The new path may generally be defined between a current location of the vehicle and an original endpoint or destination. After the new path is created, the vehicle navigates autonomously on the new path in a step 1137, and the method of responding to a detected work zone in a path of a vehicle is completed.

Alternatively, if it is determined in step 1117 that a route around is not possible or feasible, the implication is that the autonomy system was unable to define a route around that is in compliance with predetermined conditions. When a route around is determined to not be possible, the vehicle provides or initiates a supervisory request to a teleoperations monitor arrangement in a step 1121. The supervisory request is generally a request for an operator of a teleoperations monitor arrangement to monitor the environment around the vehicle, e.g., using sensors onboard the vehicle, to determine whether the vehicle may continue to operate autonomously or whether a teleoperations operation arrangement is to be substantially assigned to remotely operate the vehicle.

After the vehicle provides or initiates a supervisory request, process flow moves to an optional step 1125 in which the vehicles takes a mitigating action while awaiting a response from the teleoperations monitor arrangement. The mitigating action may include causing the vehicle to come to a stop and/or causing the vehicle to pull over to a safe location such as a side of a road.

From optional step 1125 or from step 1121, process flow proceeds to a step 1129 in which it is determined whether the vehicle is under teleoperations control. That is, it is determined whether the teleoperations monitor arrangement assigned a teleoperations operation arrangement to control the vehicle. When the vehicle is under teleoperations control, a teleoperator may remotely drive the vehicle.

If it is determined that the vehicle is not under teleoperations control, the indication is that the teleoperations monitor arrangement has determined that the vehicle may safely operate autonomously while navigating or driving around the work zone. As such, in a step 1141, the vehicle obtains information provided by the teleoperations monitor arrangement. The information may include, for example, at least one waypoint that the autonomy system may use to generate a path.

In a step 1145, the autonomy system creates a route around based on the information obtained from the teleoperations monitor arrangement. The route around may use a current location of the vehicle and at least one waypoint identified in the information as a start point and an endpoint, respectively, for the route around.

After the route around is created, the autonomy system generates a new path that includes the route around in a step 1149. The endpoint of the new path may be substantially the same as the original endpoint that the initial path the vehicle was operating along. Once the autonomy system generates the new path, the vehicle navigates autonomously on the new path in a step 1153, and the method of responding to a detected work zone in a path of a vehicle is completed.

Returning to step 1129, if it is determined that the teleoperations monitor arrangement has not placed the vehicle under teleoperations control, the indication is that the teleoperations monitor arrangement has placed the vehicle under the control of a teleoperations operation arrangement. Accordingly, in a step 1157, the vehicle is effectively navigated around the work zone by an assigned teleoperations arrangement.

From step 1157, process flow moves to a step 1161 in which the vehicle obtains a notification from the teleoperations operation arrangement that the vehicle is to resume autonomous control. In other words, after the vehicle is navigated around the work zone by the assigned teleoperations operation arrangement, the vehicle may effectively be informed by the teleoperations operation arrangement to resume autonomous control of the vehicle. In a step 1165, the vehicle navigates autonomously on the new path, and the method of responding to a detected work zone in a path of a vehicle is completed.

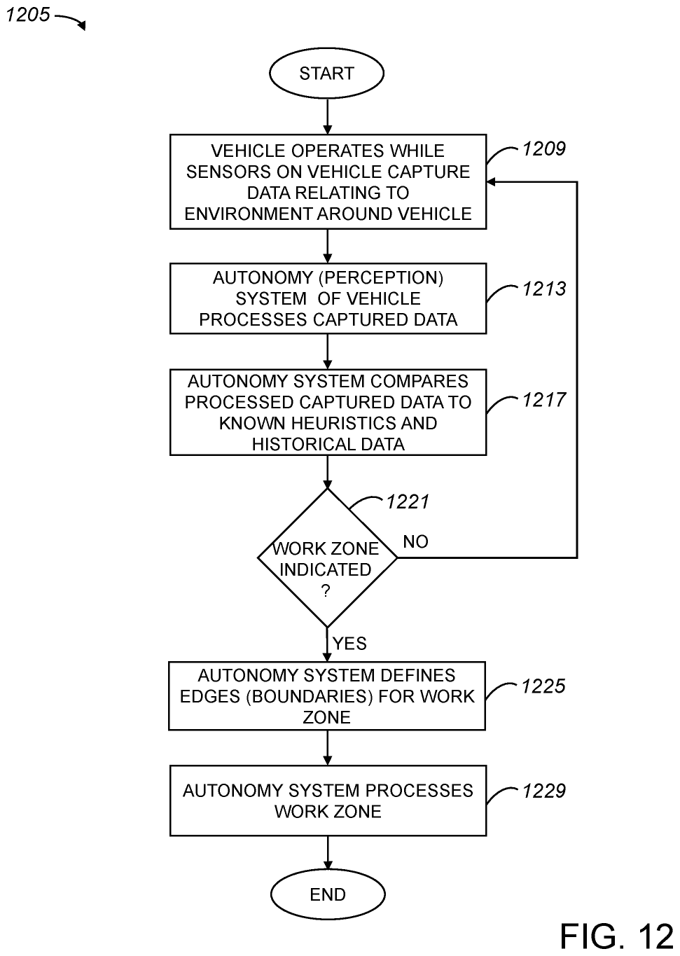

The presence of a work or construction zone along a path that is being traversed by a vehicle may be determined by an autonomy system of the vehicle. In general, perception logic of the autonomy system may use sensors on the vehicle to identify a potential work zone. Heuristics and/or historical data may be used in a determination of whether the potential work zone is likely to be an actual work zone. Referring next to FIG. 12, a method of effectively confirming a presence of a work zone will be described in accordance with an embodiment. A method 1205 of substantially confirming a presence of a work zone begins at a step 1209 in which a vehicle operates while sensors on the vehicle capture data relating to environment around the vehicle.

In a step 1213, an autonomy system of the vehicle processes the captured data. For example, the perception system of the vehicle may process the captured data to identify features in the environment around the vehicle.

Once the captured data is processed, the autonomy system compares the processed captured data to known heuristics and historical data in a step 1217. The comparison enables work zones to be identified. By way of example, heuristics and historical data relating to previously identified work zones may be used to facilitate determining when work zones are indicated in the processed captured data.

A determination is made in a step 1221 as to whether a work zone is indicated by the processed captured data. When it is determined that a work zone is not indicated, the process flow returns to step 1209 in which the vehicle continues to operate while sensors on the vehicle capture data.

Alternatively, if it is determined in step 1221 that a work zone is indicated, then in a step 1225, the autonomy system defines edges or boundaries for the work zone. Defining the edges for the work zone may generally include identifying a front edge, side edges, and a back edge. That is, the edges are identified such that the autonomy system may be aware of substantially where the work zone starts, what area is encompassed by the work zone, and where the work zone ends. Identifying edges may include, but is not limited to including, identifying locations of traffic cones, identifying locations of objects on a road, and/or identifying changes in the composition of a road surface. It should be appreciated that other factors or considerations may have an effect on the identification of edges of a work zone. Such factors or considerations may include, but are not limited to including, determining whether the position of traffic cones defines more than one work zone, determining whether the proximity of traffic cones to a curb indicates whether the work zone is on the side of a road between the traffic cones and the curb or on the side of the traffic cones away from the curb, and/or determining whether a road sign is in place which identifies the presence of a work zone.

Once the edges of the work zone are identified, process flow proceeds to a step 1229 in which the autonomy system processes the work zone. The autonomy system may process the work zone to determine whether a feasible work around may be generated, and/or to determine whether to request assistance from a teleoperations monitor arrangement. Upon the autonomy system processing the work zone, the method of substantially confirming a presence or existence of a work zone is completed.

Although only a few embodiments have been described in this disclosure, it should be understood that the disclosure may be embodied in many other specific forms without departing from the spirit or the scope of the present disclosure. By way of example, while the detection of a work zone by a vehicle has been described as essentially triggering a supervisory request to a teleoperations monitor arrangement, a supervisory request which provides information relating to a work zone may instead be substantially directly to a teleoperations operator arrangement or arrangement which is configured to operate the vehicle remotely.

Methods, e.g., algorithms, which are used to identify whether an area is a work zone may vary widely. In general, such methods include, but are not limited to including, identifying markers such as traffic cones which often indicate the existence of a work zone, identifying objects in a lane of a road or substantially adjacent to a lane on a road, and/or identifying types of objects.

The location of objects relative to an area may determine whether the area is a work zone. For example, if traffic cones are in one lane and a first vehicle is parked in or next to another lane, the existence of the traffic zones and the parked first vehicle typically does not indicate a work zone. However, if the location of the cones and the parked first vehicle may impede traffic in an oncoming direction relative to the vehicle which identified the area as a potential work zone, then the area may be identified as a work zone.

A map altering route, or a potential route between endpoints that includes a vehicle operating contrary to what is depicted on a map, may generally be identified by an autonomy system as not being navigable. As such, the vehicle may initiate a supervisory request to a teleoperations monitor arrangement to determine whether the potential route is acceptable and/or whether there is an alternate route between the endpoints that the vehicle may potentially drive autonomously. For instance, a teleoperations monitor arrangement may determine that due to the placement of traffic cones, a vehicle may safely operate autonomously between endpoints even when a route driven autonomously by the vehicle may be map altering. In other words, while a vehicle may initially determine that a map altering route is not to be driven in an autonomous manner, the vehicle may eventually drive the map altering route in an autonomous manner when a teleoperations monitor arrangement indicates that the map altering route may be driven.

A map altering route has been described as a route that may involve segments or portions which are essentially inconsistent with features shown on a map, e.g., lane directions and/or median dividers. It should be appreciated that a map altering route may generally include any route or potential route which includes substantially going against convention. By way of example, when a work zone is defined such that a lane of a road in a direction travelled by a vehicle is effectively blocked, and traffic cones or other markers are used to define a temporary driving lane on an opposite side of a median from the work zone, an autonomy system may substantially reject the potential route because the potential route includes a segment that is inconsistent with rules associated with what is depicted on a map.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
autonomously operating a vehicle along a first path from a first point to a second point, the vehicle including an autonomy system that enables the vehicle to operate autonomously, wherein the autonomy system includes a perception system;
identifying, using the perception system, a work zone;
determining, using a planning system, whether the vehicle is able to continue operating along the first path after identifying the work zone;
when it is determined that the vehicle is not able to continue operating along the first path, determining, using the autonomy system, whether the autonomy system is able to identify a second path to the second point that routes around the work zone;
when it is determined that the autonomy system is able to identify the second path, autonomously operating the vehicle along the second path; and
when it is determined that the autonomy system is unable to identify the second path, requesting assistance from a teleoperations monitor arrangement, wherein vehicle is configured to obtain, from the teleoperations monitor arrangement, one selected from a group including a waypoint and a first indication of a teleoperations operation arrangement assigned to remotely operate the vehicle around the work zone.

2. The method of claim 1 wherein when the vehicle obtains the waypoint, the autonomy system identifies a third path to the second point that includes the waypoint and routes around the work zone, and the method further includes:
autonomously operating the vehicle along the third path.

3. The method of claim 1 wherein when the vehicle obtains the first indication of a teleoperations operation arrangement assigned to remotely operate the vehicle around the work zone, the method includes:
operating the vehicle under control by the teleoperations operation arrangement on a third path around the work zone;
determining when a second indication is obtained, the second indication being arranged to indicate that the vehicle is to resume operating autonomously;
when it is determined that the second indication is obtained, identifying a third path to the second point using the autonomy system; and
autonomously operating the vehicle on the third path.

4. The method of claim 1 wherein determining, using the autonomy system, whether the autonomy system is able to identify a second path to the second point that routes around the work zone includes:
generating a potential second path that routes around the work zone;
determining an amount of deviation associated with the potential second path and the first path;
determining whether the amount of deviation is below a threshold; and
identifying the potential second path as the second path when it is determined that the amount of deviation is below the threshold.

5. The method of claim 4 wherein when it is determined that amount of deviation is not below the threshold, the autonomy system is not able to identify the second path to the second point that routes around the work zone.

6. The method of claim 1 wherein determining, using the autonomy system, whether the autonomy system is able to identify the second path to the second point that routes around the work zone includes:
identifying a potential second path that routes around the work zone;
determining whether the potential second path is consistent with traffic directions associated with a map used by the autonomy system; and
identifying the potential second path as the second path when it is determined that the potential second path is consistent with traffic directions.

7. The method of claim 1 wherein when it is determined that the vehicle is not able to continue operating along the first path, the method further includes:
taking a mitigating action using the vehicle while determining whether the autonomy system is able to identify the second path.

8. The method of claim 1 wherein when it is determined that the autonomy system is unable to identify the second path, the method further includes:
taking a mitigating action using the vehicle while requesting assistance from the teleoperations monitor arrangement.

9. Logic encoded in one or more tangible non-transitory, computer-readable media for execution and when executed operable to:
operate a vehicle autonomously along a first path from a first point to a second point, the logic operable to operate the vehicle autonomously further operable to implement a perception system;
identify, using the perception system, a work zone;
determine whether the vehicle is able to continue operating along the first path after identifying the work zone;
determine whether a second path to the second point that routes around the work zone is feasible when it is determined that the vehicle is not able to continue operating along the first path;
operate the vehicle autonomously along the second path when it is determined that the autonomy system is able to identify the second path; and
when it is determined that the autonomy system is unable to identify the second path, request assistance from a teleoperations monitor arrangement, wherein vehicle is configured to obtain, from the teleoperations monitor arrangement, one selected from a group including a waypoint and a first indication of a teleoperations operation arrangement assigned to remotely operate the vehicle around the work zone.

10. The logic of claim 9 wherein when the vehicle obtains the waypoint, the autonomy system identifies a third path to the second point that includes the waypoint and routes around the work zone, and the logic is further operable to:
autonomously operate the vehicle along the third path.

11. The logic of claim 9 wherein when the vehicle obtains the first indication of a teleoperations operation arrangement assigned to remotely operate the vehicle around the work zone, the logic is further operable to:
operate the vehicle under control by the teleoperations operation arrangement on a third path around the work zone;
determine when a second indication is obtained, the second indication being arranged to indicate that the vehicle is to resume operating autonomously;
identify a third path to the second point using the autonomy system when it is determined that the second indication is obtained; and
autonomously operate the vehicle on the third path.

12. The logic of claim 9 wherein the logic operable to determine whether the autonomy system is able to identify the second path to the second point that routes around the work zone is operable to:
generates a potential second path that routes around the work zone;
determines an amount of deviation associated with the potential second path and the first path;
determines whether the amount of deviation is below a threshold; and
identifies the potential second path as the second path when it is determined that the amount of deviation is below the threshold.

13. The logic of claim 12 wherein when it is determined that amount of deviation is not below the threshold, the autonomy system is not able to identify the second path to the second point that routes around the work zone.

14. The logic of claim 9 wherein the logic operable to determine whether the autonomy system is able to identify the second path to the second point that routes around the work zone is further operable to:
identify a potential second path that routes around the work zone;
determine whether the potential second path is consistent with traffic directions associated with a map used by the autonomy system; and
identify the potential second path as the second path when it is determined that the potential second path is consistent with traffic directions.

15. The logic of claim 9 wherein when it is determined that the vehicle is not able to continue operating along the first path, the logic is operable to:
take a mitigating action using the vehicle while determining whether the autonomy system is able to identify the second path.

16. A system comprising:
a teleoperations monitor arrangement; and
a vehicle, the vehicle including an autonomy system having logic operable to operate the vehicle autonomously along a first path from a first point to a second point, the logic operable to operate the vehicle autonomously further being operable to implement a perception system, the perception system including logic operable to identify a work zone along the first path, wherein the autonomy system further includes logic operable to determine whether the vehicle is able to continue operating along the first path after identifying the work zone and to determine whether a second path to the second point that routes around the work zone is feasible when it is determined that the vehicle is not able to continue operating along the first path, and wherein when the logic operable to determine whether the second path is feasible determines that the second path is not feasible, the logic is further operable to provide a supervisory request to the teleoperations monitor arrangement, the teleoperations monitor arrangement being arranged to determine whether the vehicle is capable of operating autonomously around the work zone.

17. The system of claim 16 further including:
a teleoperations operation arrangement, the teleoperations operation arrangement configured to remotely operate the vehicle, wherein the teleoperations monitor arrangement is configured to assign the teleoperations operation arrangement to remotely operate the vehicle when it is determined that the vehicle is not capable of operating autonomously around the work zone.

18. The system of claim 17 wherein when it is determined that the vehicle is capable of operating autonomously around the work zone, the teleoperations monitor arrangement identifies a waypoint and provides the waypoint to the vehicle, and wherein the autonomy system determines a third path, the third path including the waypoint and arranged to route around the work zone.

19. The system of claim 18 wherein the autonomy system causes the vehicle to operate autonomously on the third path after the autonomy system determines the third path.

20. The system of claim 16 wherein the autonomy system further includes logic operable to operate the vehicle autonomously along the second path when it is determined that the second path is feasible.
